(19) United States
(12) Patent Application Publication
(10) Pub. No.: US 2007/0299674 A1
(43) Pub. Date: Dec. 27, 2007

(54) Methods and systems for candidate medical assessment

(76) Inventors: Bonnie J. Timko, Manassas, VA (US); Gary Ehlert, Buffalo, NY (US); Yvonnecris Veal, St. Albans, NY (US); Ellen Mahoney, Point Lookout, NY (US); Lillian R. Weiss, New Orleans, LA (US); Alvee Carlini, New Orleans, LA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/315,059

(22) Filed: Dec. 22, 2005

Related U.S. Application Data
(63) Continuation-in-part of application No. 11/157,259, filed on Jun. 21, 2005, now abandoned.
(60) Provisional application No. 60/580,698, filed on Jun. 21, 2004.

(51) Int. Cl. G06Q 10/00

(52) U.S. Cl. 705/1

(57) ABSTRACT

Disclosed methods and systems include providing a medical assessment in which it is determined if a candidate is medically suitable for employment based on a standardized process and medical information associated with a candidate. The process includes analyzing the answers in the medical information for an inconsistency.

### RELATED APPLICATION

The present application is a continuation-in-part of U.S. patent application Ser. No. 11/157,259 filed on Jun. 21, 2005, which claims the benefit of U.S. Provisional Patent Application No. 60/580,698 filed on Jun. 21, 2004, both of which are entitled “Methods And Systems For Providing Candidate Medical Assessment,” and both of which are hereby incorporated by reference.

### TECHNICAL FIELD

The present invention generally relates to methods and systems for the medical assessment of candidates for employment. More particularly, the present invention relates to the medical assessment of candidates using a standardized process to determine the medical suitability of candidates for employment based on current medical information.

### BACKGROUND

In order to perform the medical assessment of candidates for employment, a manual process is typically performed which may include the completion of a number of paper forms. Currently, candidates complete a medical form that includes questions regarding their medical history to date. The medical form may include a series of “yes/no” questions regarding the candidates' physical condition. In some instances, the “yes/no” questions may require further explanations.

Once the candidate has completed the first form, a physician may perform a physical examination of the candidate and complete another form (e.g., a medical examination or medical assessment form), which may include the title of the position for which the candidate is being considered, as well as the environmental and functional requirements of the position. Based on the physical examination and the forms, the physician makes a determination about the candidate's risk for performing the tasks required by the position. As a result of the determination of the physician, the candidate may be placed into one of three risk assessment categories (e.g., no medical limitations, moderate risk/restrictions, and high risk). This manual process provides a turnaround time of 10-12 days for a medically-suitable candidate.

Using this manual process, the accuracy and the quality of the examinations may vary based on, for example, the experience level of the physician, the manner in which the examination is performed by the physician, and the number of examinations that a physician performs in a given period of time. Consequently, the determination of a candidate's risk assessment category may vary based on factors associated with the physical examination of the candidate.

Based on assessment of the current methodology, e.g., the manual process, it has been determined that, if the age group of the candidates is appropriately selected, the majority of the predictive value of the medical assessment is based on the medical history of the candidate and is not based on the findings from the physical examination of the candidate. It follows that if the medical history of the candidate is properly documented and evaluated in a systematic manner, inaccuracy in the medical risk assessments of candidates may be reduced. Therefore, improved methods and systems for providing candidate medical assessments are needed.

### SUMMARY

In one aspect, a method provides performance data for a medical assessment system. The method includes providing medical assessments for a plurality of candidates, storing information generated by the medical assessments of the plurality of candidates, and reporting at least one characteristic of the stored information.

In another aspect, a method provides a history of a medical assessment of a candidate for employment. The method includes providing a medical assessment, storing information generated in the medical assessment of the candidate, and providing information about the medical assessment, wherein the information includes an identifier and a status.

In another aspect, a method evaluates a candidate's suitability for employment. The method includes receiving application information associated with a candidate, generating a plurality of documents including at least some of the application information, and providing a medical assessment of the candidate.

In one or more of the foregoing methods, the medical assessment includes receiving medical information associated with a candidate and determining if the candidate is medically suitable based on a standardized process. The medical information comprises a plurality of answers. The standardized process includes analyzing the answers for an answer that suggests at least one of a medical issue, an inadequate comprehension of the question, an omission, and a mistake; and analyzing the answers for an inconsistency. The medical assessment further includes providing a notification that indicates (a) that the candidate is employable if it is determined that the candidate is medically suitable for employment; and/or (b) that there is a need to provide additional medical information if it is undetermined whether the candidate is employable.

In another aspect, a system, which provides data relating to one or more medical assessments, features a memory storage device and a processing unit coupled to the memory storage device. The memory storage device and the processing unit are configured to perform one or more of the foregoing methods. Another aspect of the invention is a computer-readable medium comprising instructions to configure a computer to execute one or more of the foregoing methods.

Features and principles consistent with the disclosed methods and systems may facilitate faster or more efficient evaluation of a candidate's suitability for employment. Features and principles consistent with the present invention may facilitate access to or review and/or analysis of the history of a candidate evaluation. Features and principles consistent with the present invention may facilitate faster, more standardized, more predictable, and/or more accurate medical assessment of a candidate for employment. Features and principles consistent with the present invention may additionally or alternatively make medical assessment of a plurality of candidates more efficient and less expensive by identifying a subset of candidates for whom more exhaustive assessment is appropriate. Features and principles consistent with the present invention may facilitate faster, more thorough, and/or more accurate evaluation of a medical assessment system. The present invention may also be particularly suitable for a high-volume hiring environment.

It is understood that both the foregoing general description and the following detailed description are exemplary and explanatory only, and are not restrictive of the invention as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings:

FIG. 1 is a block diagram of a system for providing medical assessment for candidates, consistent with the present invention;

FIG. 2 illustrates an exemplary method for providing a medical assessment of a candidate, consistent with the present invention;

FIG. 3 is a block diagram showing exemplary relationships between data and processes consistent with the present invention;

FIG. 4 is a flow chart of an exemplary method for providing a medical assessment of a candidate, consistent with the present invention;

FIGS. 5A and 5B are a flow chart of another exemplary method for providing a medical assessment of a candidate, consistent with the present invention;

FIG. 6 illustrates an exemplary method for providing performance data for a medical assessment system, consistent with the present invention;

FIG. 7 illustrates an exemplary method for providing a history of a medical assessment of a candidate, consistent with the present invention; and

FIG. 8 illustrates an exemplary method for streamlining the evaluation of a candidate for employment, consistent with the present invention.

### DESCRIPTION OF THE EMBODIMENTS

Features and principles consistent with the present invention are based in part on the recognition that standardized methods and systems for candidate evaluation have some benefit. For example, where methods and systems for providing a medical assessment include the determination of whether a candidate is medically suitable for employment based on a standardized process, information associated with the medical assessment may be stored, thereby enabling metrics relating to the methods and systems to be generated. Similarly, for another example, information about the history of the medical assessment of an individual candidate may be made available. For another example, one or more tasks associated with the evaluation of a candidate's suitability for employment may be automated thereby increasing the efficiency of the evaluation process.

The following detailed description refers to the accompanying drawings. Wherever possible, the same reference numbers are used in the drawings and the following description to refer to the same or similar parts.

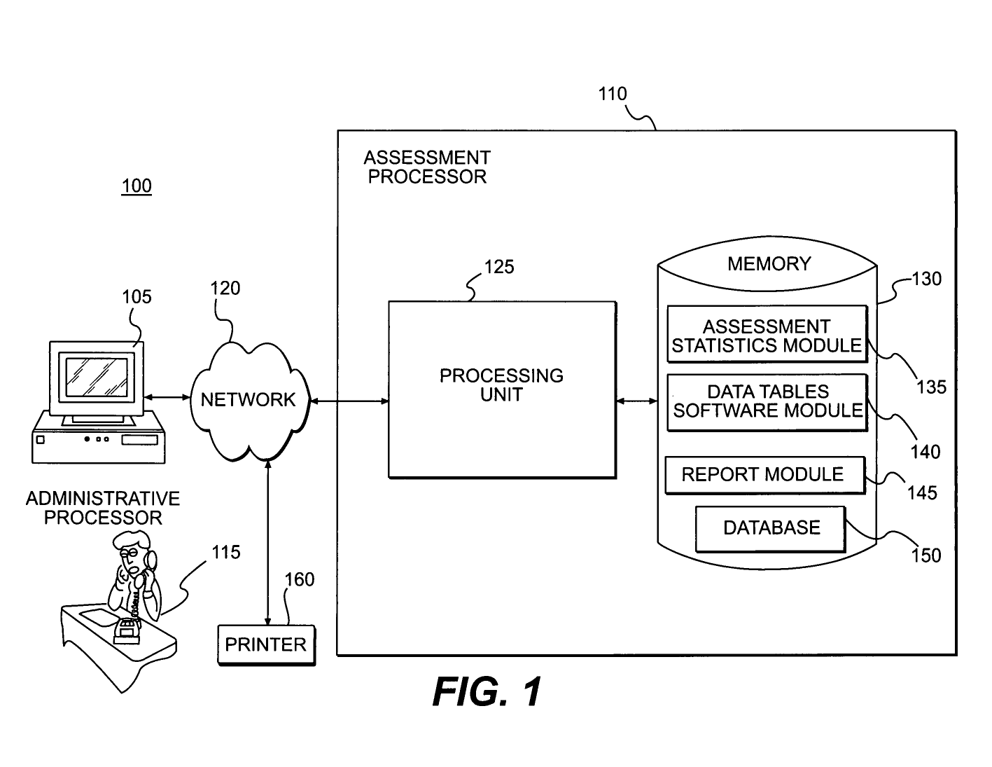

FIG. 1 is a block diagram of a system 100 for providing medical assessment for candidates, consistent with an embodiment of the present invention. System 100, which may be in used in the evaluation of candidate's suitability for employment, includes a memory storage device 130 and a processing unit 125 coupled to the memory storage device. Memory storage device 130 and processing unit 125 are configured to perform a method that includes receiving medical information associated with a candidate and determining if the candidate is medically suitable for employment based on a standardized process. Memory storage device 130 and processing unit 125 are further configured to perform additional functions based on the result of the standardized process. As illustrated in FIG. 1, memory storage device 130 and processing unit 125 may be components of an assessment processor 110, which is part of the larger system 100. In the embodiment of FIG. 1, system 100 further includes an administrative processor 105, a printer 160, and a network 120. Administrative processor 105 enables a user to access system 100 in FIG. 1. Printer 160 enables a user to print information accessible on system 100. User 115 may be an individual, such as a human resources staff member or an Occupational Health Nurse Administrator (OHNA).

Any suitable combination of hardware, software, and/or firmware may be used to implement memory storage device 130, processing unit 125, and other components of system 100. Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general-purpose computer or in any other circuits or systems.

For example, administrative processor 105 and assessment processor 110 (“the processors”) included in system 100 may be implemented using a personal computer, network computer, mainframe, or other similar microcomputer-based workstation. The processors may also comprise any other types of processing devices, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

Network 120 may comprise, for example, a local area network (LAN) or a wide area network (WAN). Such networking environments are commonplace in offices, enterprise-wide computer networks, Intranets, and the Internet, and are known by those skilled in the art. When a LAN is used as network 120, a network interface located at any of the processors may be used to interconnect any of the processors. When network 120 is implemented in a WAN networking environment, such as the Internet, the processors may typically include an internal or external modem (not shown) or other means for establishing communications over the WAN. Further, in utilizing network 120, data sent over network 120 may be encrypted to ensure data security by using known encryption/decryption techniques.

In addition to utilizing a wire line communications system as network 120, a wireless communications system, or a combination of wire line and wireless may be utilized as network 120 in order to, for example, exchange web pages via the Internet, exchange e-mails via the Internet, or utilize other communications channels. Wireless can be defined as radio transmission via the airwaves. However, it may be appreciated that various other communication techniques can be used to provide wireless transmission, including infrared, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission.

System 100 may also transmit data by methods and processes other than, or in combination with, network 120. These methods and processes may include, but are not limited to, transferring data via, diskette, CD ROM, facsimile, conventional mail, an interactive voice response system (IVR), or via voice over a publicly switched telephone network.

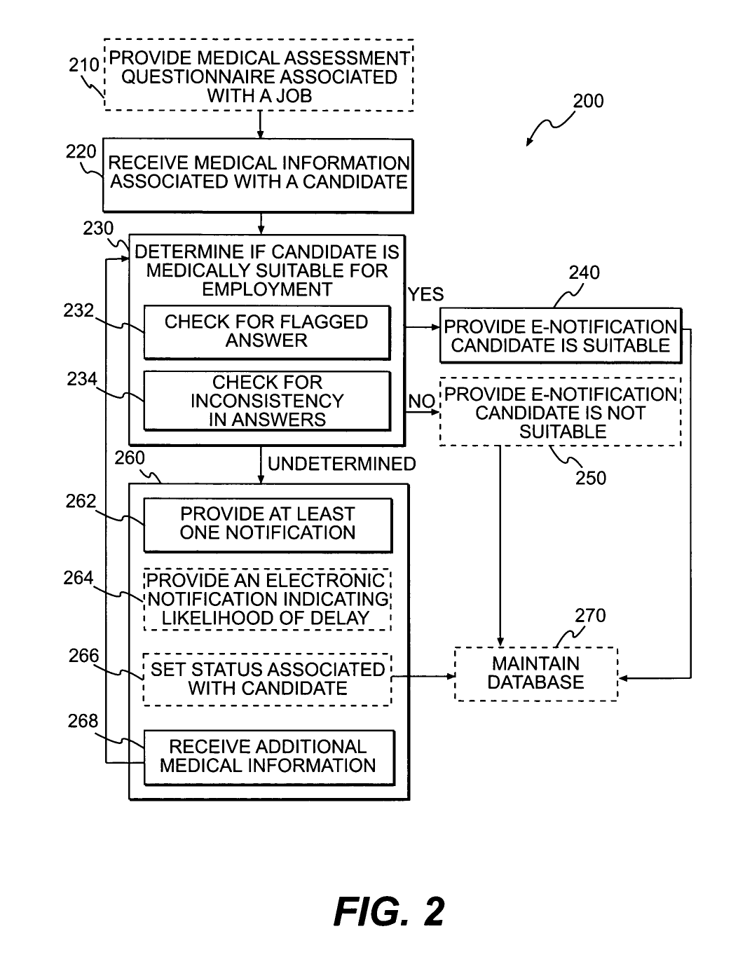

System 100 may implement one or more of the disclosed methods. For instance, system 100 may implement an exemplary method for, providing a medical assessment of a candidate 200, illustrated in FIG. 2. A candidate may be anyone seeking employment who has not yet begun working in the desired position. For example, a candidate may have received an offer for employment contingent on meeting certain criteria.

Method 200 will now be described with reference to FIG. 2. In stage 210 of method 200, system 100 provides a medical assessment questionnaire associated with the job sought by the candidate. Questions on the medical assessment questionnaire may take into account the functional requirements and/or the environmental requirements of the job. The functional requirements may include, for example, the requirement to walk a certain number of hours per day; the requirement to pull hand-over-hand; and the requirement to repeatedly bend over. The environmental requirements may include, for example, the requirement to work in excessive heat, the requirement to work in constant noise, and the requirement to work in dusty conditions. The candidate may be required to provide medical information in the form of answers to questions regarding his medical history to date. In some embodiments, these answers are associated with the provided medical assessment questionnaire.

In stage 220, system 100 receives medical information associated with a candidate. In one embodiment, the medical information is received in the form of scanned answer sheet. In another embodiment, the medical information takes the form of touch-tone responses to questions provided by an interactive voice response system. Such medical information may need to be converted to a more readily usable form.

In stage 230, system 100 determines if the candidate is medically suitable for employment based on the standardized process. The standardized process may determine, for example, whether a candidate meets the physical requirements for a specific job. The standardized process includes, but is not necessarily limited to, stages 232 and 234. In stage 232, system 100 checks for an answer in the medical information that suggests a medical issue, an intent to deceive, an inadequate comprehension of a question, an omission, and/or a mistake. In some embodiments, the foregoing problems are identified by flags associated with possible answers. In stage 234 of method 200, system 100 checks the answers in the medical information for inconsistency. In some embodiments, inconsistency is determined based on an inconsistency table.

Method 200 in system 100 includes providing a notification based on the result of the standardized process. In stage 240, system 100 provides a notification, such as an electronic notification that the candidate is employable if it is determined that the candidate is medically suitable for employment. In some embodiments of the invention, this may indicate that the candidate does not have any medical issues and/or that the candidate can meet the environmental and functional requirements for the job. In stage 250, system 100 provides a notification that the candidate is not employable if it is determined that the candidate is not medically suitable for employment. In some embodiments of the invention, this may indicate that the candidate has a major medical issue and/or that the candidate cannot meet the environmental and functional requirements for the job. In some embodiments, the notification will also include a reason why the candidate is not employable.

If a determination cannot be made in stage 230, system 100 performs a number of functions in stage 260. In stage 262, system 100 provides a notification indicating a need to provide additional medical information. Such a notification may result in a request for additional medical documentation, an interview, a medical consultation, or a physical exam. In one alternative embodiment of the invention, system 100 provides a notification indicating a likelihood of delay if appropriate based on the additional medical information needed. In optional stage 266, system 100 sets a status associated with the candidate until the additional medical information is received or until a pre-determined period of time has elapsed. In stage 268, system 100 may receive additional medical information in response to the notification. Finally, system 100 may return to stage 230 using the initial medical information and the additional medical information to determine if the candidate is medically suitable for employment.

Optionally, system 100 may maintain a database including the result of stage 230 in stage 270. The result of stage 230 may be a pending status for embodiments featuring stage 266. In one such embodiment, the method 200 further includes checking the database for a result of stage 230 associated with the candidate before performing a repeat execution of stage 230.

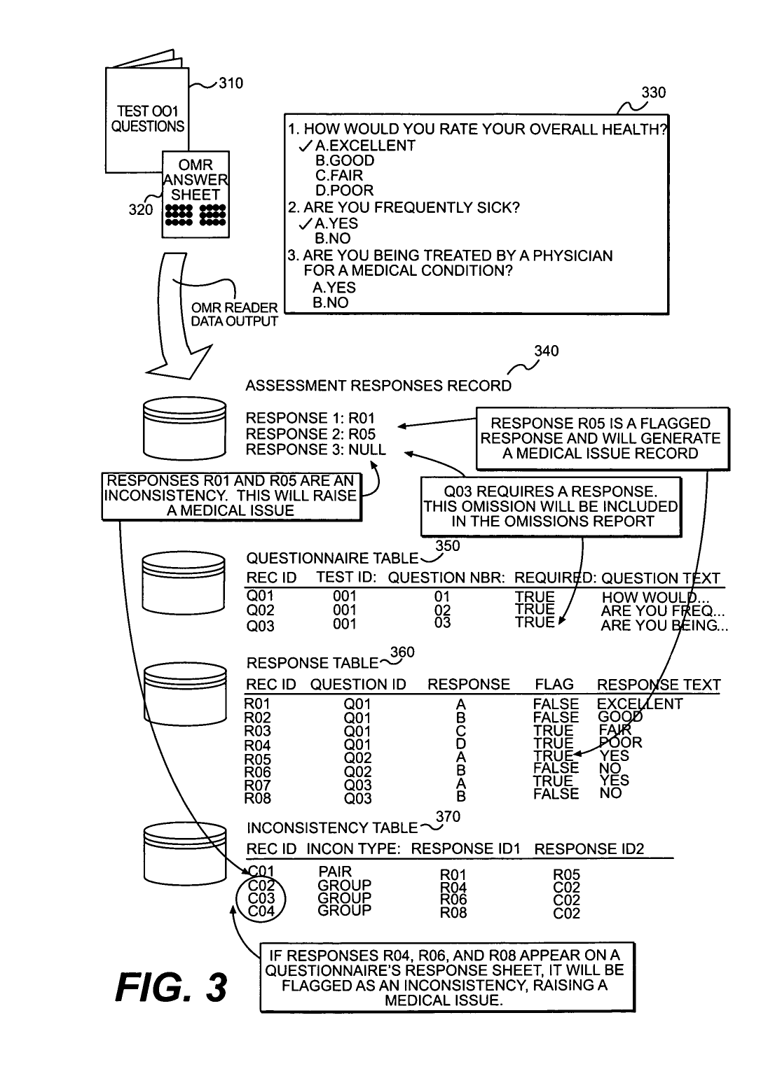

FIG. 3 is a block diagram showing exemplary relationships between data and processes consistent with the present invention. The exemplary relationships in FIG. 3 may be useful to system 100 in performing stages 230, 232, and 234 of method 200.

In particular, FIG. 3 illustrates a medical assessment questionnaire 310, an answer sheet 320, and a block 330 illustrating the relationship between a plurality of questions in the medical assessment questionnaire 310 and a plurality of answers on answer sheet 320. Some embodiments of the invention include multiple medical assessment questionnaires—each associated with a particular job, a class of jobs, functional requirements, and/or environmental requirements. As block 330 shows, medical assessment questionnaire 310 may include questions having two or more possible answers. Answer sheet 320 is associated with a particular medical assessment questionnaire 310.

In some embodiments of the invention, an assessment responses record 340 is created from the medical information received by system 100. In one such embodiment, the candidate writes his answers on an answer sheet. The answer sheet is then scanned to generate an electronic list of the answers. The list of answers is then correlated to the possible answers in the associated medical assessment questionnaire 310. For example, block 330 illustrates three questions and eight possible answers associated with medical assessment questionnaire 310. A typical medical assessment questionnaire would have more questions and more possible answers. As an illustration, an exemplary medical assessment questionnaire may have approximately 80 questions. Block 330 further illustrates that the candidate has selected the first possible answer in response to the first question, the fifth possible answers in response to the second question, and no answer to the third question in the medical information received by system 100. Accordingly, assessment responses record 340 lists three response rows with the first possible answer in the first row, the fifth possible answer in the second row, and a null value representing no answer in the third row.

FIG. 3 also illustrates a plurality of tables including a questionnaire table 350, a response table 360, and an inconsistency table 370.

Questionnaire table 350 identifies each question by its number on a particular medical assessment questionnaire 310. Questionnaire table 350 includes a required field or column that indicates on a question-by-question basis whether an answer from the candidate is required. In the example shown in FIG. 3, questionnaire table 350 indicates that a response to each of the questions in medical assessment questionnaire 310 is required. Since assessment responses record 340 contains a null value in the third row representing no answer to the third question of the relevant medical assessment questionnaire 310 and questionnaire table 350 indicates that a response to that question is required (i.e., for Rec ID: Q03; Test ID: 001; Question Nbr: 03; the Required field value is True), the medical information does not include a required answer. Accordingly, in some embodiments, system 100 generates an omissions report for the candidate.

Response table 360 identifies each possible answer to a question on a particular medical assessment questionnaire 310 by its number. A “flag” field of response table 360 identifies whether each possible answer on a particular medical assessment questionnaire 310, by itself, suggests an issue. Response table 360 indicates that the third, fourth, fifth, and seventh possible responses associated with medical assessment questionnaire 310, by themselves, suggest an issue. For example, since assessment responses record 340 contains the fifth possible response in the second row representing a “yes” response to the second question (“Are you frequently sick?) of the relevant medical assessment questionnaire 310 and response table 360 indicates that response is flagged [i.e., for Rec ID: R05; Question ID: Q02; Response: A; the Flag field value is True], the medical information includes an answer that suggests an issue. Accordingly, in some embodiments, system 100 generates a medical issue report for the candidate.

Inconsistency table 370 identifies subsets of possible answers to questions on a particular medical assessment questionnaire 310 that represent a possible inconsistency. For example, inconsistency table 370 illustrates that the fifth, sixth, and eighth possible answer in block 330 (i.e., R04, R06, and R08 in response table 360) represent a possible inconsistency (i.e., Rec Ids: C02, C03, and C04; Incon Type: Group; groups Response ID1's: R04, R06, and R08 together under Response ID2: C02). Similarly, inconsistency table 370 illustrates that the first and fifth possible answer in block 330 (i.e., R01 and R05 in response table 360) represent a possible inconsistency (i.e., Rec Ids: C01; Incon Type: Pair; pairs Response ID1: R01 with Response ID2: R05). If the answer sheet 320 includes responses that suggest a possible inconsistency, such as illustrated as the first and second response in assessment responses record 340 in FIG. 3, an inconsistency is identified. Accordingly, in some embodiments, system 100 may generate a medical issue report for the candidate.

The exemplary relationships between data in FIG. 3 may be useful to system 100 in performing stages 230, 232, and 234 of method 200. A candidate's answers may enable system 100 to determine that the candidate is medically suitable for employment in which case system 100 provides the appropriate notification in stage 240 of method 200. Correspondingly, a candidate's answers may enable system 100 to determine that the candidate is not medically suitable for employment, in which case system 100 provides the appropriate notification in stage 250 of method 200.

Both a candidate's answers and a candidate's failure to provide a required answer may prevent system 100 from determining if the candidate is medically suitable for employment. Answers that may prevent system 100 from determining if the candidate is medically suitable for employment include answers that suggest a mistake, an omission, an inadequate comprehension of one or more questions, an intent to mislead, or a possible medical issue. If system 100 is unable to determine if the candidate is or is not medically suitable for employment, it will proceed to stage 260 of method 200 and provide a notification indicating a need to provide additional medical information in stage 262. In various embodiments, such a notification may include a request for a medical interview, a request for additional medical documentation, a request for a medical consultation, and/or a request for a focused physical examination.

Referring again to FIG. 1, memory storage device 130 may include, for example, an assessment statistics software module 135, a data tables software module 140, a report software module 145, and a database 150. Memory storage device 130 also may include at least one medical assessment questionnaire 310, at least one assessment responses record 340, questionnaire table 350, response table 360, and inconsistency table 370. Software modules 135, 140, 145 residing in memory storage device 130 may be executed on processing unit 125 using data on memory storage device 130 or elsewhere.

Assessment statistics software module 135 collects and maintains data associated with system 100 to enable the generation of performance indicators. Assessment statistics software module 135 may associate a date and time with one or more events in the method that system 100 is configured to perform, such as the occurrence of stage 210 or stage 220 of method 200. Relevant performance indicators may include the number of medical assessments initiated; the number of medical assessments completed or resolved; the number of candidates cleared by medical information alone; the number of assessments fully resolved in a medical interview alone; the number of assessments requiring a medical consultation before being fully resolved; the number of assessments requiring a focused physical exam; the number of the foregoing that the physician found employable; the number of the foregoing for which the physician issued a restriction; the number of the foregoing that the physician found unemployable; the number of assessments closed due to the lapse of allowable time to process; and the number of assessments that could not be moved forward due to an exceptional event (i.e., uncooperative candidate).

Performance indicators may be grouped by accounting period, fiscal year-to-date, or other relevant period. Performance indicators may be grouped by job-related characteristic or category. Performance indicators may be grouped by candidate-related characteristic or category. Exemplary performance indicators may include average time per period to complete an assessment with its standard deviation; average time per period to complete a phase in the process of assessment with its standard deviation (e.g., time from notification of need for focused physical exam to receipt of associated report); number of assessments by craft; and age at time of assessment by five-year intervals with average mean age and standard deviation.

Performance indicators may be grouped by district, area, and/or any other relevant geographical or business division. Performance indicators may be provided in the form of percentages of a whole, in addition to or instead of absolute numbers. Exemplary performance indicators may include the percentage of medical assessments completed or resolved within 24 hours of a medical interview in district 2; the percentage of medical assessments requiring a physical exam in area 1; the resolved medical assessments as a percentage for each quarter of a fiscal year; the percentage of medical assessments closed in district 7 as compared all districts; medical assessment for a craft as a percentage of total assessments; the percentage of medical assessments resolved by each available method; and percentage of medical assessments for each gender.

Data tables software module 140 includes questionnaire table 350, response table 360, and inconsistency table 370, such as in an embodiment consistent with FIG. 3. The data tables software module 140 may also include, for example, data tables for archive history data, appointment data tables, examinee user data tables, and other tables used by system 100 to determine if the candidate is medically suitable for employment.

Report software module 145 in memory storage device 130 of FIG. 1 may generate the notification of stages 240, 250, and 262 of method 200, as shown in FIG. 3. Report software module 145 additionally may generate other reports, such as an omissions report, a medical issue report, or a focused physical examination guidance report. These reports may be used for guidance in providing additional medical information. In one embodiment, the medical issue report is the notification of stage 250. Additionally or alternatively, assessment processor 110 may generate reports. These reports may include medical information associated with the candidate. Each section of these reports may include unique candidate identifiers to identify the candidate. Report software module 145 in memory storage device 130 may additionally or alternatively generate reports of performance indicators using assessment statistics software module 135.

In embodiments of the invention that include maintaining a database, memory storage device 130 may include database 150. In some embodiments, database 150 includes the result of determining if the candidate is medically suitable for employment. In one embodiment, the result is employable, pending, unemployable, or restricted. In one embodiment, database 150 may include the results associated with at least 500 candidates in one year.

Database 150 may include a wide range of information, as described below. In some embodiments, database 150 may further include additional data such as the medical information associated with the candidate, any additional medical information associated with the candidate, and the history and status of methods 200, 400, or 500 as related to the candidate. In embodiments of the invention with database 150, the method may further include checking database 150 for the result associated with the candidate prior to determining if the candidate is medically suitable for employment. Portions of database 150 may be archived periodically to ensure the proper operation of system 100. In some embodiments, database 150 is a component of assessment statistics software module 135.

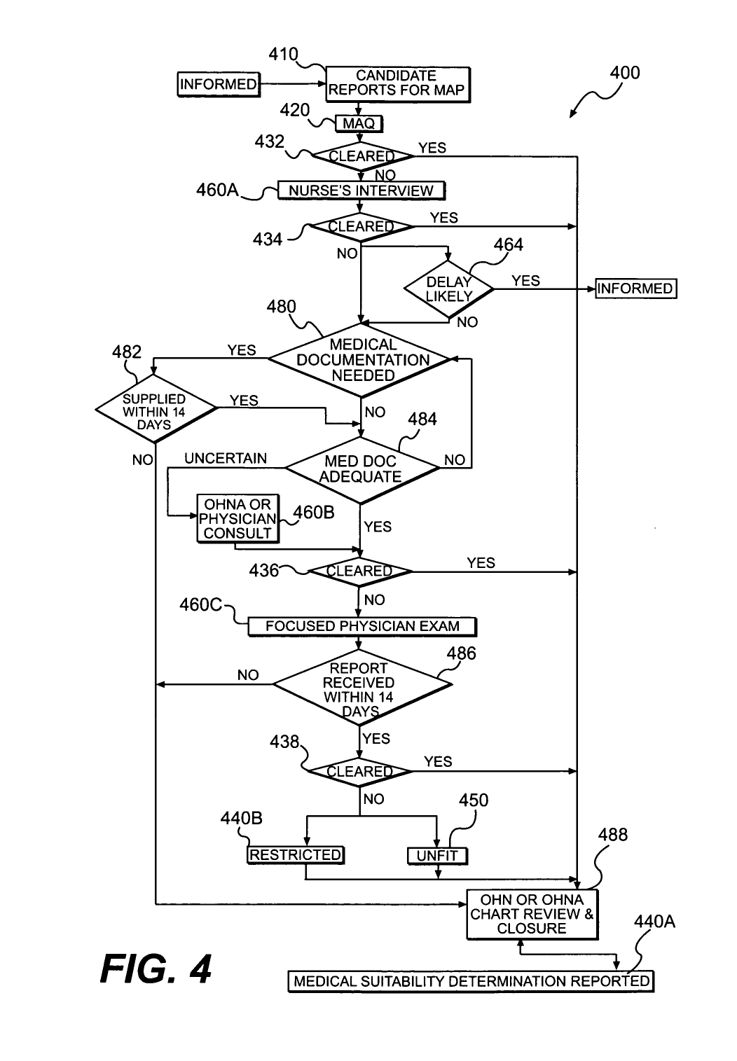

FIG. 4 is a flow chart of an exemplary method for providing a medical assessment of a candidate, consistent with the present invention. In one embodiment, method 400 provides for a medical assessment of a candidate using system 100 of FIG. 1. Exemplary ways to implement the stages of exemplary method 400 are described in greater detail below. In stage 410, system 100 provides a medical assessment questionnaire. In stage 420, system 100 receives medical information associated with the candidate in a usable electronic format. In stage 432, system 100 determines if the candidate is medically suitable for employment based on a standardized process. In one embodiment, the standardized process includes checking for an answer in the medical information that suggests an issue and checking for a subset of answers in the medical information that suggests an inconsistency.

If the candidate is determined to be medically suitable for employment in stage 432, system 100 proceeds to stage 488 in which a report is provided to a user. The user may be, for example, an Occupational Health Nurse (OHN) or an Occupational Health Nurse Administrator (OHNA). The report in some embodiments enables the user to validate system 100's determination that the candidate is employable. The report in other embodiments simply alerts the user that no further action is to be taken with respect to the candidate. Then, system 100 proceeds to stage 440A where it provides a notification that the candidate is employable.

If the candidate is not determined to be medically suitable for employment in stage 432, system 100 proceeds to stage 460A. In some embodiments, system 100 performs a number of functions in stage 460A. For example, in one embodiment consistent with method 400, system 100 notifies the user of the need for a nurse's interview, provides at least one report outlining what additional medical information that is needed, and receives additional medical information from the interview. The one or more reports may include a report of omissions of necessary answers to be provided in the interview; a report of apparent inconsistencies to be discussed in the interview; and a report listing answers that suggest an issue to be discussed in the nurse's interview. The candidate may provide additional medical information that overcomes any omissions, apparent consistencies, and possible issues in the nurse's interview. After receiving the additional medical information in stage 460A, system 100 proceeds to stage 434.

In stage 434, system 100 again determines if the candidate is medically suitable for employment. If the candidate is determined to be medically suitable for employment in stage 434, system 100 proceeds to stage 488 in which a report is provided to a user. Then, system 100 proceeds to stage 440A where it provides a notification that the candidate is employable. If the candidate is not determined to be medically suitable for employment in stage 434, system 100 proceeds to stages 464 and 480. In stage 464, system 100 determines if a delay is likely and generates a notification if appropriate.

In stage 480, system 100 determines if additional medical information is needed in the form of medical documentation. If additional medical documentation is needed, system 100 checks if it has been provided within a time period, for example 14 days, in stage 482. If the documentation is provided within the time period, for example 14 days, or if additional medical documentation is not needed, system 100 proceeds to stage 484. If the available medical documentation is not adequate, system 100 returns to stage 480.

If in stage 482 it is determined that the additional medical documentation has not been provided within the time period, for example 14 days, system 100 proceeds to stage 488 and 440A. In stage 488, system 100 provides a report is provided to the user. The report in some embodiments simply alerts the user that no further action is to be taken with respect to the candidate. In stage 440A, system 100 provides a notification that the candidate is not employable.

In stage 484, system 100 determines if the available medical documentation is adequate. If it is uncertain whether the available medical documentation is adequate, system 100 proceeds to stage 460B in method 400. In some embodiments, system 100 performs a number of functions in stage 460B. For example, in one embodiment consistent with method 400, system 100 notifies the user of the need to get additional medical information from a medical consultation, provides at least one report outlining what additional medical information is needed, and receives additional medical information from the medical consultation. The one or more reports could include a report describing an issue to be discussed in the medical consultation. The candidate may provide additional medical information that resolves the issue in the medical consultation.

After receiving additional medical information from the medical consultation in stage 460B or if the available medical documentation is determined to be adequate in stage 484, system 100 proceeds to stage 436. In stage 436, system 100 again determines if the candidate is medically suitable for employment. If the candidate is determined to be medically suitable for employment in stage 436, system 100 proceeds to stages 488 and 440A as previously described with respect to stages 432 and 434. If the candidate is not determined to be medically suitable for employment in stage 436, system 100 proceeds to stage 460C.

In some embodiments, system 100 performs a number of functions in stage 460C. For example, in one embodiment consistent with method 400, system 100 notifies the user of the need to get additional medical information from a focused physical exam and provide at least one report providing guidance on the medical issue to be addressed in the physical exam. The guidance could include, for example, descriptions of the functional requirements of the job, the environmental requirements of the job, and an issue to be considered in the focused physical exam. A doctor or nurse practitioner may obtain additional medical information from the candidate that resolves the medical issue in the focused physical exam.

In stage 486, system 100 determines whether a report providing the additional medical information from the focused physical exam has been received within the time period, for example 14 days. If the report was not received, system 100 proceeds to stages 488 and 440A as previously described with respect to stage 482. If the report was received within the time period, for example 14 days, system 101 proceeds to stage 438.

In stage 438, system 100 determines if the candidate is medically suitable for employment. If the candidate is determined to be medically suitable for employment in stage 438, system 100 proceeds to stages 488 and 440A as previously described with respect to stages 432, 434, and 436.

If the candidate is not determined to be medically suitable for employment in stage 438, system 100 proceeds to stage 440B or stage 450. System 100 either deems the candidate unfit for employment in stage 450 or deems the candidate to be restricted in stage 440B. Thereafter, system 100 proceeds to stages 488 in which a report is provided to a user. The report in some embodiments enables the user to validate system 100's determination that the candidate is either unfit for employment or restricted. The report in other embodiments simply alerts the user that no further action is to be taken with respect to the candidate. Thereafter, system 100 proceeds to stage 440A where it provides a notification of the final determination on whether the candidate is employable.

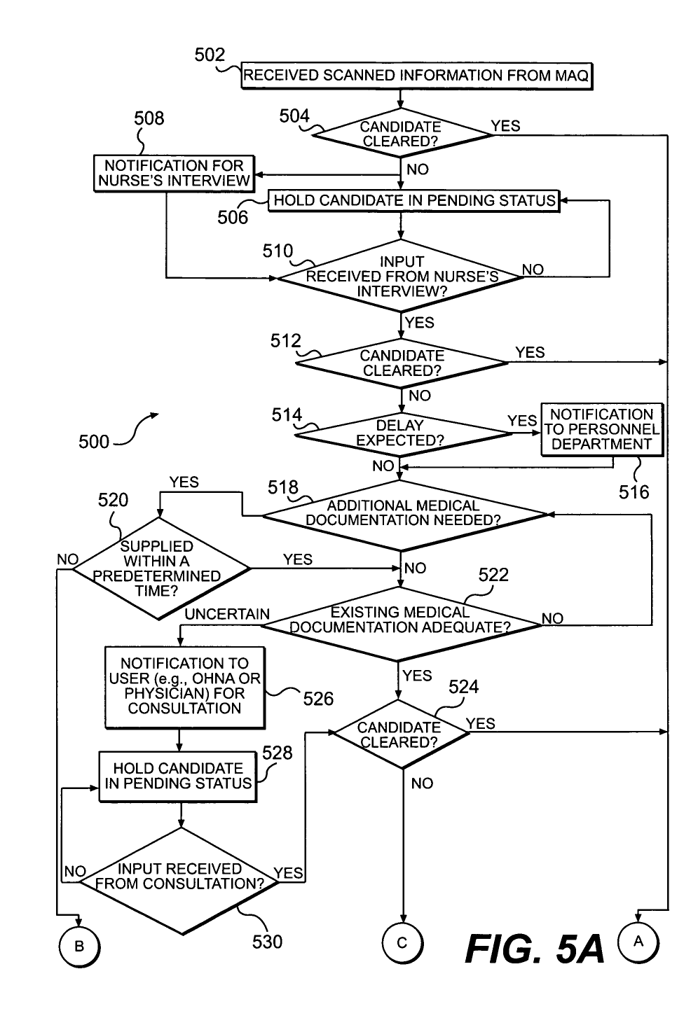

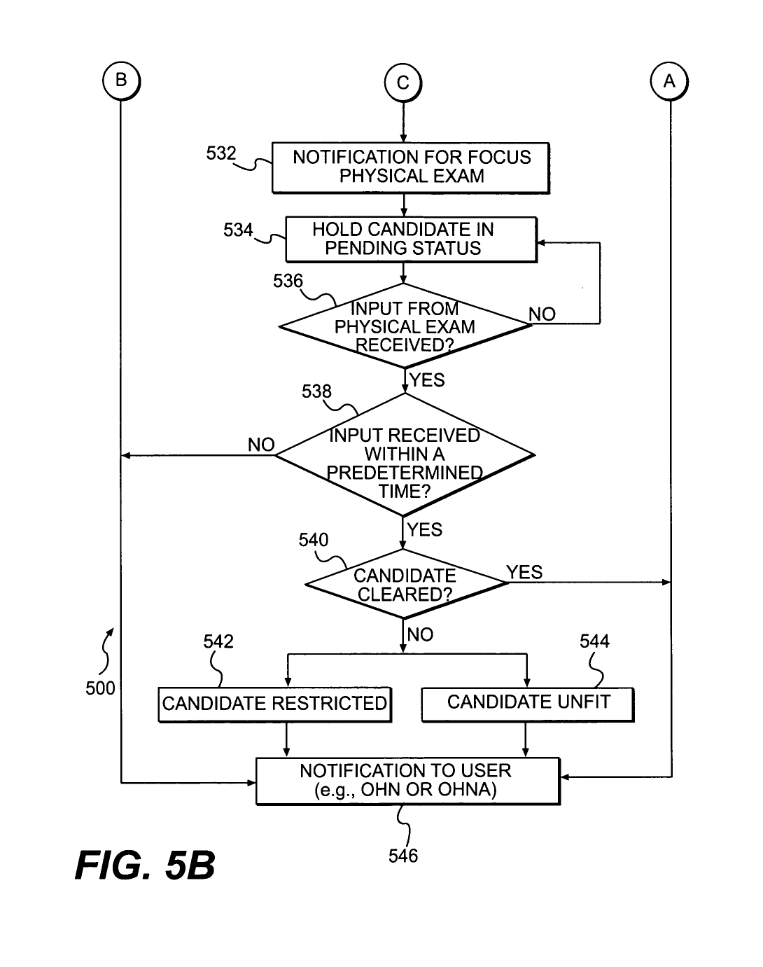

FIGS. 5A and 5B are a flow chart of an exemplary method for providing a medical assessment of a candidate, consistent with the present invention. For example, FIGS. 5A and 5B illustrate exemplary method 500 for providing a medical assessment of a candidate using system 100 of FIG. 1. Exemplary ways to implement the stages of exemplary method 500 are described in greater detail below. In stage 502 of method 500, system 100 receives scanned medical information associated with a medical assessment questionnaire (MAQ). Although scanning is used to describe the conversion of medical information to an electronic format that may be used by system 100, other means may be used for converting the medical information into an electronic format that may be used by system 100. For example, the candidate may be provided with a pointing device for selecting answers to questions posed on an electronic display screen. A resulting file including the candidate responses may then be transferred to system 100.

The questions posed to the candidate in the medical assessment questionnaire may include groups of questions with interlinking relationships. The questions may be designed in a manner that a candidate's current and past physical condition may be assessed. Based on the assessment, it may be determined whether the candidate may satisfy the functional and environmental requirements of the job sought by the candidate.

In stage 504 of method 500, system 100 determines whether the candidate is medically suitable for the job. If the candidate is cleared, system 100 proceeds to stage 546 of method 500 and a notification is provided to a user. The user may be, for example, an Occupational Health Nurse (OHN) or an Occupational Health Nurse Administrator (OHNA). If the candidate is not cleared at stage 504, system 100 proceeds to stages 506 and 508 of method 500. In stage 508, system 100 may provide the user with notification to submit the candidate to a nurse's interview. Personnel may also be notified of the nurse's interview. In stage 506, system 100 sets the candidate's status to pending until additional medical information is received from the nurse's interview. In stage 510 of method 500, system 100 determines whether input has been received from the nurse's interview. If no input has been received, system 100 returns to stage 506 and maintains the candidate in pending status. However, if input has been received from the nurse's interview, system 100 proceeds to stage 512 to determine whether the candidate is cleared for the position.

If at stage 512 the candidate is cleared, system 100 proceeds to stage 546 of method 500. If at stage 512 the candidate is not cleared, system 100 determines whether a delay is expected in stage 514 of method 500. If a delay is expected, in stage 516, system 100 provides a notification (e.g., to the personnel department) indicating that the candidate may not be cleared within a predetermined time. If no delay is expected or stage 516 is done, system 100 proceeds to stage 518.

In stage 518, system 100 determines whether additional medical documentation is needed to substantiate the medical condition of the candidate. If it is determined that no additional medical document is needed, system 100 proceeds to stage 522. In stage 522, system 100 determines whether the existing medical documentation for the candidate is adequate. If it is determined that additional medical documentation is needed, system 100 proceeds to stages 518 and 520. In stage 518, system 100 determines whether input for the medical documentation has been received within a predetermined time. If the medical documentation input has not been supplied within the predetermined time, the candidate is not cleared and system 100 proceeds to stage 546 at which a notification may be provided to a user.

If at stage 520, however, the medical documentation has been provided within the predetermined time, system 100 proceeds to stage 522 in which it determines whether the existing medical documentation for the candidate is adequate. If the medical documentation is not adequate, system 100 returns to stage 518 and again determines if additional medical documentation is needed to substantiate the medical condition of the candidate. If the existing medical documentation is adequate, system 100 proceeds to stage 524 in which it determines whether the candidate should be cleared for the position.

However, if at stage 522 system 100 is unable to make a determination of whether the medical documentation is adequate, the determination is classified as “uncertain.” Then, in stage 526 of method 500, system 100 provides a notification to the user to schedule a consultation with the candidate. In stage 528 of method 500, system 100 keeps the candidate's status as pending while the consultation occurs. In stage 530 of method 500, system 100 determines whether additional medical information from the consultation has been received.

System 100 returns to stage 528 if at stage 530 the additional medical information has not been received from the consultation. Once the additional medical information is received, however, system 100 proceeds to stage 524 and determines whether the candidate is cleared. If the candidate is cleared in stage 546 of method 500, system 100 provides a notification to a user. If the candidate is not cleared, however, system proceeds to stage 532 (FIG. 5B) where it provides a notification to the user to schedule and perform a focused physical exam. In stage 534 of method 500, system 100 keeps the candidate's status as pending while the focused physical exam occurs. In stage 536 of method 500, system 100 determines whether additional medical information from the focused physical exam has been received. If additional medical information has not been received, system 100 returns to stage 534.

Once additional medical information is received from the physical exam, however, system 100 proceeds to stage 538 and determines whether it was received within a predetermined time of the notification for a focused physical exam. If the additional medical information is not received within the predetermined time, the candidate is not cleared and system 100 proceeds to stage 546 where it provides a notification to the user. If the additional medical information from the focus physical exam is provided within the predetermined time, system 100 proceeds to stage 540 and determines whether the candidate is cleared or not. If the candidate is cleared, system 100 proceeds to stage 546 and provides an appropriate notification to a user. If the candidate is not cleared, system 100 may determine that the candidate is unfit for the job sought in stage 544 or that the candidate may be classified as restricted in stage 542. Either way, system 100 then proceeds to stage 546 where it provides an appropriate notification to the user.

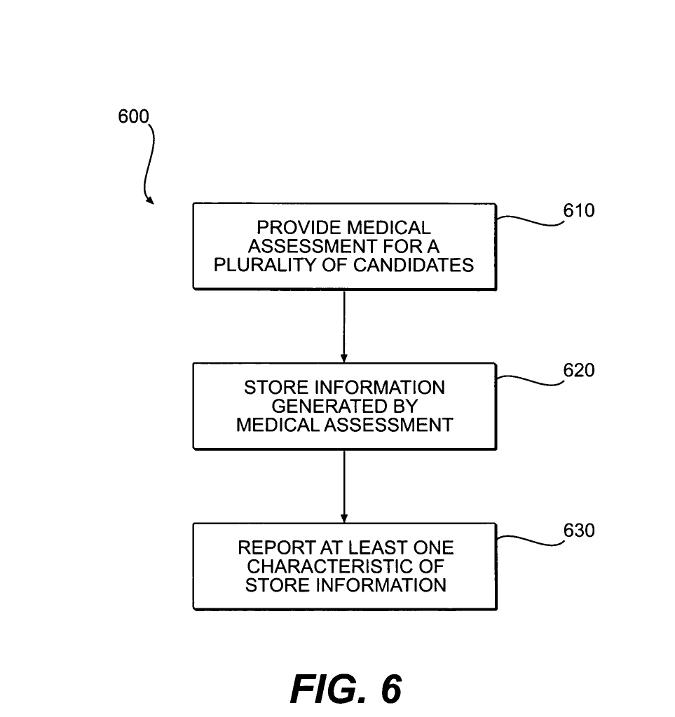

FIG. 6 illustrates an exemplary method for providing performance data for a medical assessment system, consistent with the present invention. In stage 610 of method 600, system 100 provides a medical assessment for a plurality of candidates. In stage 620 of method 600, system 100 stores information generated by the medical assessment of the plurality of candidates. Stages 610 and 620 are intimately related and, particularly since stage 610 involves a plurality of candidates, are not necessarily sequential. The generated information may include any information that could contribute to the types of performance indicators described above. System 100 may store the information, for example, in assessment statistics module 135 and/or database 150. Periodically, information may be moved to a less readily accessible portion of memory 130 or archived. Information in database 150 may digested and moved to assessment statistics module 135.

In stage 630 of method 600, system 100 reports at least one characteristic of the stored information. The characteristic may be the portion of memory 130 taken up by the store information. The characteristic may be a performance indicator as described above. System 100 may use printer 160 to report the characteristic. Additionally or alternatively, system 100 may use administrative processor 105 to report the characteristic. Report module 145 may enable user 115 to specify the characteristic of the stored information to report. Stage 630 may include reporting a plurality of predetermined performance indicators in a batch-type process. Characteristic information may be reported in a digital form to facilitate further analysis.

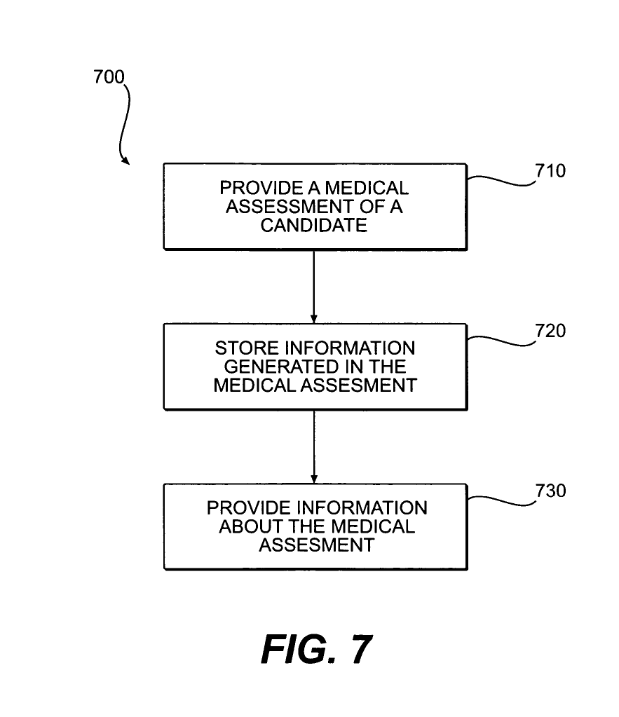

FIG. 7 illustrates an exemplary method for providing a history of a medical assessment of a candidate, consistent with the present invention. In stage 710 of method 700, system 100 provides a medical assessment for a candidate. In stage 720 of method 700, system 100 stores information generated by the medical assessment of the candidate. Like stages 610 and 620 of method 600, stages 710 and 720 of method 700 are intimately related and are not necessarily sequential. The generated information may include any information that could contribute to the types of performance indicators described above. The information may include the candidate's personal information, assignment details, and case history. The personal information may include the candidate's name, address, social security number, date of birth, age, gender, disability status, veteran status, any special compensation status, telephone number, and contact information. The assignment details may include the fiscal year, the accounting period (AP) on a monthly basis, the month or other calendar period, job category, career status, and any referring and/or employing installations. The case history may include any events that occurred during the assessment process, along with the dates and times and who performed any steps in the process. System 100 may store the information in database 150.

In stage 730 of method 700, system 100 provides information about the medical assessment including an identifier and a status. The identifier may include any portion of the candidate's personal information selected to distinguish that candidate from others. The identifier, for example, may include the candidate's last name and certain digits of the candidate's social security number. The information provided in stage 730 does not necessarily include all of the information stored in stage 720. System 100 may use administrative processor 105 to provide the information. System 100 may use printer 160 to provide the information. Report module 145 may enable user 115 to specify the information to be provided.

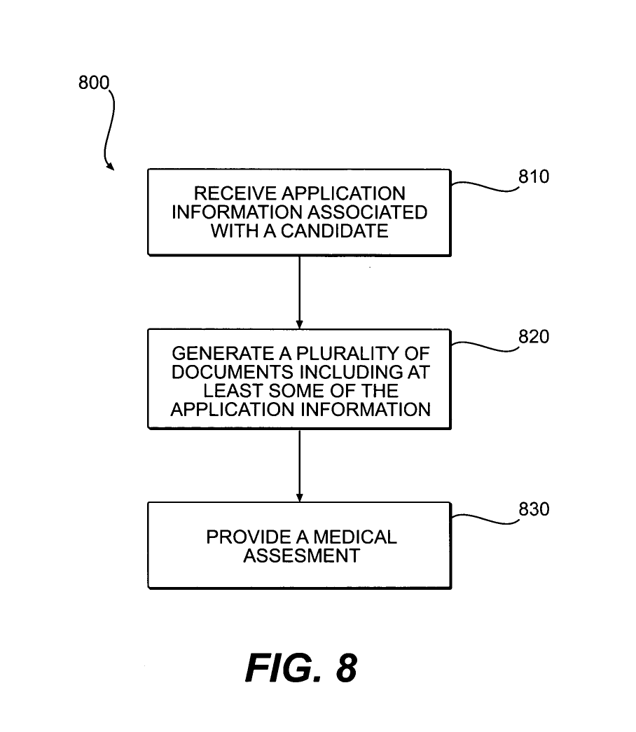

FIG. 8 illustrates an exemplary method for evaluating a candidate for employment, consistent with the present invention. In stage 810 of method 800, system 100 receives application information associated with a candidate. Application information may include, for example, the candidate's personal information and one or more assignment details for the candidate's target job. Application information may be received in a digital form. Alternatively, user 115 may enter the application information into memory 130 via administrative processor 105 from information provided by the candidate.

In stage 820 of method 800, system 100 generates a plurality of documents including at least some of the application information. The documents may be used to streamline the evaluation of a candidate by providing the candidate with job-related information, schedule information, process information, and/or one or more forms that may be needed. The documents may include the following: a letter informing the candidate of an appointment for a medical assessment, for providing medical information, for a medical examination, for providing a medical sample, for a drug screening test, or for any other evaluation event; a letter providing the candidate instructions relating to the evaluation process, such as any conditions imposed on a job offer, and a form to be completed by the candidate's private physician if the candidate has been treated for a medical condition within a specified period of time; a description of the functional and/or environmental requirements of the relevant job; a form enabling the candidate to declare a physical and/or mental disability; and a consent and/or release form.

One or more of the plurality of documents may be printed after they are generated. The documents may be printed in a batch process. In embodiments in which the plurality of documents are printed, an identifier may be included on each printed page. In stage 830 of method 800, system 100 provides a medical assessment of the candidate.

One of ordinary skill in the art will also appreciate that the invention may be implemented in a computer-readable medium (e.g., floppy disk, CD-ROM, storage device, etc.) containing instructions for a system, such as system 100, to execute the method for providing a medical assessment of a candidate.

While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding stages to the disclosed methods.

It is intended, therefore, that the specification and examples be considered as exemplary only, with a true scope and spirit of the invention being indicated by the following claims and their full scope of equivalents.

1. A method for providing performance data for a medical assessment system, the method comprising:
providing medical assessments for a plurality of candidates comprising:
receiving medical information associated with the candidate, wherein the medical information comprises a plurality of answers to questions supplied to the candidate;
determining if the candidate is medically suitable for employment based on a standardized process comprising:
analyzing the answers for an answer that suggests at least one of a medical issue, an inadequate comprehension of the question, an omission, and a mistake; and
analyzing the answers for an inconsistency;
if it is determined that the candidate is medically suitable for employment, providing an automatic electronic notification indicating that the candidate is medically suitable for employment; and
if it is undetermined whether the candidate is employable based on the medical information, providing an automatic electronic notification indicating a need to provide additional medical information;
storing assessment information associated with the medical assessments of the plurality of candidates in a database accessible via a network; and
reporting at least one characteristic of the stored assessment information.

2. The method of claim 1 wherein the at least one characteristic relates to a period of time.

3. The method of claim 1 wherein the at least one characteristic relates to a geographic area.

4. The method of claim 1 wherein the at least one characteristic relates to a period of time and an area.

5. The method of claim 1 wherein the at least one characteristic is a number of candidates for whom a determination is reached.

6. The method of claim 1 wherein the at least one characteristic is a number of candidates for whom a determination is reached without additional medical information.

7. A method for providing a history of a medical assessment of a candidate for employment, the method comprising:
providing a medical assessment comprising:
receiving medical information associated with a candidate, wherein the medical information comprises a plurality of answers to questions supplied to the candidate;
determining if the candidate is medically suitable for employment based on a standardized process comprising:
analyzing the answers for an answer that suggests at least one of a medical issue, an inadequate comprehension of the question, an omission, and a mistake; and
analyzing the answers for an inconsistency;
if it is determined that the candidate is medically suitable for employment, providing an automatic electronic notification indicating that the candidate is medically suitable for employment; and
if it is undetermined whether the candidate is employable based on the medical information, providing an automatic electronic notification indicating a need to provide additional medical information;
storing assessment information associated with the medical assessment of the candidate in a database accessible via a network; and
providing at least a portion of the assessment information, wherein the provided assessment information includes an identifier and a status.

8. The method of claim 7 further comprising providing personal information about the candidate.

9. The method of claim 7 further comprising providing assignment information about the candidate.

10. The method of claim 7 wherein the assessment information comprises at least one event that occurred in the medical assessment.

11. The method of claim 7 wherein the assessment information comprises at least one of dates, times, and people associated with at least one event that occurred in the medical assessment.

12. A method for evaluating a candidate's suitability for employment, the method comprising:
receiving application information associated with a candidate;
automatically electronically generating a plurality of documents including at least a portion of the application information;
providing a medical assessment comprising:
receiving medical information associated with a candidate, wherein the medical information comprises a plurality of answers to questions supplied to the candidate;
determining if the candidate is medically suitable for employment based on a standardized process comprising:
analyzing the answers for an answer that suggests at least one of a medical issue, an inadequate comprehension of the question, an omission, and a mistake; and
analyzing the answers for an inconsistency;
if it is determined that the candidate is medically suitable for employment, providing an automatic electronic notification indicating that the candidate is medically suitable for employment; and
if it is undetermined whether the candidate is employable based on the medical information, providing an automatic electronic notification indicating a need to provide additional medical information.

13. The method of claim 12 wherein the application information comprises the name of the candidate, the date of birth of the candidate, a category of job for which the candidate applied, and the facility at which the candidate applied to work.

14. The method of claim 12 wherein the application information further comprises the Social Security number of the candidate.

15. The method of claim 12 wherein one of the plurality of documents comprises a notification to inform the candidate of an appointment for a medical sample to be taken.

16. The method of claim 12 wherein one of the plurality of documents comprises a notification to inform the candidate of a date, time, and location for a medical examination to be conducted.

17. The method of claim 12 wherein one of the plurality of documents comprises a notification to inform the candidate of a date, time, and location at which to provide medical information.

18. The method of claim 12 wherein one of the plurality of documents comprises a description of the functional requirements associated with a category of job for which the candidate applied.

19. The method of claim 12 wherein one of the plurality of documents comprises a form on which the candidate may declare a disability.

20. The method of claim 12 wherein one of the plurality of documents comprises a form on which a physician may describe a medical condition requiring treatment.

21. The method of claim 12 wherein one of the plurality of documents comprises instructions for the candidate regarding the evaluation process.

22. The method of claim 12 wherein each page of at least one of the plurality of documents includes application information that uniquely identifies the candidate.

23. A system for providing performance data relating to medical assessments of candidates, the system comprising:
a memory storage device; and
a processing unit coupled to the memory storage device, wherein the memory storage device and the processing unit are configured with instructions that perform a method comprising:
providing medical assessments for a plurality of candidates comprising:
receiving medical information associated with one the plurality of candidates, wherein the medical information comprises a plurality of answers to questions supplied to the candidate;
determining if the candidate is medically suitable for employment based on a standardized process comprising:
analyzing the answers for an answer that suggests at least one of a medical issue, an inadequate comprehension of the question, an omission, and a mistake; and
analyzing the answers for an inconsistency;
if it is determined that the candidate is medically suitable for employment, providing an automatic electronic notification indicating that the candidate is medically suitable for employment; and
if it is undetermined whether the candidate is employable based on the medical information, providing an automatic electronic notification indicating a need to provide additional medical information;
storing assessment information associated with the medical assessments of the plurality of candidates in a database accessible via a network; and
reporting at least one characteristic of the stored assessment information.

24. The system of claim 23 wherein the at least one characteristic relates to a period of time.

25. The system of claim 23 wherein the at least one characteristic relates to an area.

26. The system of claim 23 wherein the at least one characteristic is a number of candidates for whom a determination is reached.

27. A system for providing a history of a medical assessment of a candidate, the system comprising:
a memory storage device; and
a processing unit coupled to the memory storage device, wherein the memory storage device and the processing unit are configured with instructions that perform a method comprising:
providing a medical assessment comprising:
receiving medical information associated with a candidate, wherein the medical information comprises a plurality of answers to questions supplied to the candidate;
determining if the candidate is medically suitable for employment based on a standardized process comprising:
analyzing the answers for an answer that suggests at least one of a medical issue, an inadequate comprehension of the question, an omission, and a mistake; and
analyzing the answers for an inconsistency;
if it is determined that the candidate is medically suitable for employment, providing an automatic electronic notification indicating that the candidate is medically suitable for employment; and
if it is undetermined whether the candidate is employable based on the medical information, providing an automatic electronic notification indicating a need to provide additional medical information;
storing assessment information associated with the medical assessment of the candidate in a database accessible via a network; and
electronically providing at least a portion of the assessment information, wherein the provided assessment information includes an identifier and a status.

28. The system of claim 27 wherein the information further comprises at least one event that occurred in the medical assessment.

29. A system for streamlining the evaluation of a candidate's suitability for employment, the system comprising:
a memory storage device; and
a processing unit coupled to the memory storage device, wherein the memory storage device and the processing unit are configured with instructions that perform a method comprising:
receiving application information associated with a candidate;
automatically electronically generating a plurality of documents including at least a portion of the application information;
providing a medical assessment comprising:
receiving medical information associated with a candidate, wherein the medical information comprises a plurality of answers to questions supplied to the candidate;
determining if the candidate is medically suitable for employment based on a standardized process comprising:
analyzing the answers for an answer that suggests at least one of a medical issue, an inadequate comprehension of the question, an omission, and a mistake; and
analyzing the answers for an inconsistency;
if it is determined that the candidate is medically suitable for employment, providing an automatic electronic notification indicating that the candidate is medically suitable for employment; and
if it is undetermined whether the candidate is employable based on the medical information, providing an automatic electronic notification indicating a need to provide additional medical information.

30. The system of claim 29 wherein the application information comprises the name of the candidate, the date of birth of the candidate, a category of job for which the candidate applied, and the facility at which the candidate applied to work.

31. The system of claim 29 wherein one of the plurality of documents comprises a notification to inform the candidate of a date, time, and location at which to provide medical information.

32. The system of claim 29 wherein one of the plurality of documents comprises a description of the functional requirements associated with a category of job for which the candidate applied.

33. The system of claim 29 wherein each page of at least one of the plurality of documents includes application information that uniquely identifies the candidate.

34. A computer-readable medium comprising instructions to configure a processor to execute a method for providing performance data for a medical assessment system, the method comprising:
providing a medical assessments for a plurality of candidates comprising:
receiving medical information associated with one the plurality of candidate, wherein the medical information comprises a plurality of answers to questions supplied to the candidate;
determining if the candidate is medically suitable for employment based on a standardized process comprising:
analyzing the answers for an answer that suggests at least one of a medical issue, an inadequate comprehension of the question, an omission, and a mistake; and
analyzing the answers for an inconsistency;
if it is determined that the candidate is medically suitable for employment, providing an automatic electronic notification indicating that the candidate is medically suitable for employment; and
if it is undetermined whether the candidate is employable based on the medical information, providing an automatic notification indicating a need to provide additional medical information;
storing assessment information associated with the medical assessment of the plurality of candidates in a database accessible via a network; and
reporting at least one characteristic of the stored assessment information.

35. The computer-readable medium of claim 34 wherein the at least one characteristic is a number of candidates for whom a determination is reached without additional medical information.

36. The computer-readable medium of claim 34 wherein the at least one characteristic relates to a period of time.

37. A computer-readable medium comprising instructions to configure a computer to execute a method for providing a history of a medical assessment of a candidate, the method comprising:
providing a medical assessment comprising:
receiving medical information associated with a candidate, wherein the medical information comprises a plurality of answers to questions supplied to the candidate;
determining if the candidate is medically suitable for employment based on a standardized process comprising:
analyzing the answers for an answer that suggests at least one of a medical issue, an inadequate comprehension of the question, an omission, and a mistake; and
analyzing the answers for an inconsistency;
if it is determined that the candidate is medically suitable for employment, providing an automatic electronic notification indicating that the candidate is medically suitable for employment; and
if it is undetermined whether the candidate is employable based on the medical information, providing an automatic electronic notification indicating a need to provide additional medical information;
storing assessment information associated with the medical assessment of the candidate in a database accessible via a network; and
electronically providing at least a portion of the assessment information, wherein the provided assessment information includes an identifier and a status.

38. The computer-readable medium of claim 37 wherein the information further comprises at least one event that occurred in the medical assessment.

39. The computer-readable medium of claim 37 wherein the information further comprises dates, times, and people associated with at least one event that occurred in the medical assessment.

40. A computer-readable medium comprising instructions to configure a computer to execute a method for streamlining the evaluation of a candidate's suitability for employment, the method comprising:
receiving application information associated with a candidate;
automatically electronically generating a plurality of documents including at least a portion of the application information;
providing a medical assessment comprising:
receiving medical information associated with a candidate, wherein the medical information comprises a plurality of answers to questions supplied to the candidate;
determining if the candidate is medically suitable for employment based on a standardized process comprising:
analyzing the answers for an answer that suggests at least one of a medical issue, an inadequate comprehension of the question, an omission, and a mistake; and
analyzing the answers for an inconsistency;
if it is determined that the candidate is medically suitable for employment, providing an automatic electronic notification indicating that the candidate is medically suitable for employment; and
if it is undetermined whether the candidate is employable based on the medical information, providing an automatic electronic notification indicating a need to provide additional medical information.

41. The computer-readable medium of claim 40 wherein the method further comprises receiving additional medical information in response to the at least one notification; determining if the candidate is medically suitable for employment within minutes based on the standardized process using the medical information and the additional medical information; and maintaining a database comprising a result for the candidate.

42. The computer-readable medium of claim 40 wherein the method further comprises providing an automatic electronic notification indicating a likelihood of delay if appropriate based on the additional medical information needed.
